(19) United States
(12) Patent Application Publication
(10) Pub. No.: US 2020/0244879 A1
(43) Pub. Date: Jul. 30, 2020

(54) IMAGING SYSTEM, DEVELOPING SYSTEM, AND IMAGING METHOD

(71) Applicant: Daisuke HOHJOH, Chiba (JP)

(72) Inventor: Daisuke HOHJOH, Chiba (JP)

(73) Assignee: Ricoh Company, Ltd., Tokyo (JP)

(21) Appl. No.: 16/752,811

(22) Filed: Jan. 27, 2020

(30) Foreign Application Priority Data
Jan. 30, 2019 (JP) 2019-014876

(51) Int. Cl. H04N 5/232; H04N 9/64

(52) U.S. Cl. CPC H04N 5/23238; H04N 9/646; H04N 5/23229; H04N 5/23293

(57) ABSTRACT

An imaging system includes an imaging unit configured to capture a plurality of fisheye images; an arranged image generating unit configured to generate an arranged image in which the plurality of fisheye images are arranged; a thumbnail image generating unit configured to generate a thumbnail image that includes at least a part of a spherical image, the spherical image being generated based on the plurality of fisheye images; and an output unit configured to output output data that includes the arranged image and the thumbnail image.

### CROSS-REFERENCE TO RELATED APPLICATIONS

The present application claims priority under 35 U.S.C. § 119 to Japanese Patent Application No. 2019-014876, filed on Jan. 30, 2019, the entire contents of which are incorporated herein by reference.

### BACKGROUND OF THE INVENTION

### 1. Field of the Invention

The disclosures herein relate to an imaging system, a developing system, and an imaging method.

### 2. Description of the Related Art

Conventionally, an omnidirectional imaging system that uses multiple wide-angle lenses such as fisheye lenses or super wide-angle lenses to capture an omnidirectional image (hereinafter referred to as a “spherical image”) at one time is known (see Patent Document 1, for example).

In such an omnidirectional imaging system, in order to properly perform a RAW development process for images of objects captured in all directions, it is preferable to output the captured raw image data to an external device such as a personal computer (PC) or a tablet, and perform the RAW development process on the external device. For example, there is known an omnidirectional imaging system capable of outputting captured RAW image data to an external device (see Non-Patent Document 1, for example).

However, in the related-art omnidirectional imaging systems, raw image data contains a plurality of fisheye images that are simply arranged and combined. Thus, even if a user views a thumbnail image displayed on a display unit of the external device, it may be difficult for the user to identify at a glance where an image was captured.

### RELATED-ART DOCUMENTS

### Patent Documents

Patent Document 1: Japanese Patent No. 6256513

### Non-Patent Documents

Non-Patent Document 1: Internet URL

<https://www.insta360.com/product/insta360-pro2/>

### SUMMARY OF THE INVENTION

According to an embodiment of the present invention, an imaging system includes an imaging unit configured to capture a plurality of fisheye images; an arranged image generating unit configured to generate an arranged image in which the plurality of fisheye images are arranged; a thumbnail image generating unit configured to generate a thumbnail image that includes at least a part of a spherical image, the spherical image being generated based on the plurality of fisheye images; and an output unit configured to output output data that includes the arranged image and the thumbnail image.

### BRIEF DESCRIPTION OF THE DRAWINGS

Other objects and further features of the present invention will be apparent from the following detailed description when read in conjunction with the accompanying drawings, in which:

FIG. 1 is a diagram illustrating a configuration of a developing system according to an embodiment;

FIG. 2 is a block diagram illustrating an example of a hardware configuration of an omnidirectional camera according to the embodiment;

FIG. 3 is a diagram illustrating examples of fisheye images captured by the omnidirectional camera;

FIG. 4 is a diagram illustrating a spherical image captured by the omnidirectional camera;

FIG. 5 is a block diagram illustrating an example of a hardware configuration of a developing apparatus according to the embodiment;

FIG. 6 is a block diagram illustrating an example of a functional configuration of the omnidirectional camera according to a first embodiment;

FIG. 7 is a block diagram illustrating a functional configuration of the developing apparatus according to the first embodiment;

FIG. 8 is a diagram illustrating an example of a screen displaying thumbnail images according to the embodiment and thumbnail images according to a comparative example;

FIG. 9 is a diagram illustrating an example of a screen displaying an arranged image according to the embodiment;

FIG. 10 is a sequence diagram illustrating an example of a process performed by the developing system according to the first embodiment;

FIG. 11 is a block diagram illustrating a functional configuration of an omnidirectional camera according to a second embodiment; and

FIG. 12 is a sequence diagram illustrating an example of a process performed by a developing system according to the second embodiment.

### DESCRIPTION OF THE EMBODIMENTS

It is a general object of the present invention to increase the visibility of a thumbnail image so as to allow a user to identify at a glance where an image was captured.

In the following, embodiments of the present invention will be described with reference to the accompanying drawings. In the drawings, the same elements are denoted by the same reference numerals, and a duplicate description may be omitted.

In the following embodiments, an omnidirectional camera (an example of an “imaging system”) capable of capturing an omnidirectional image at one time, and a developing system that includes a developing apparatus configured to perform a development process on a spherical image captured by the omnidirectional camera will be described.

As used herein, the “development process” refers to a process for electronically adjusting exposure, white balance, hue, and other settings of a RAW image that has been captured by, for example, a digital camera but has not yet processed. In the following description, the above-described process is referred to as a “RAW development process”.

### <Configuration of Developing System According to Embodiment>

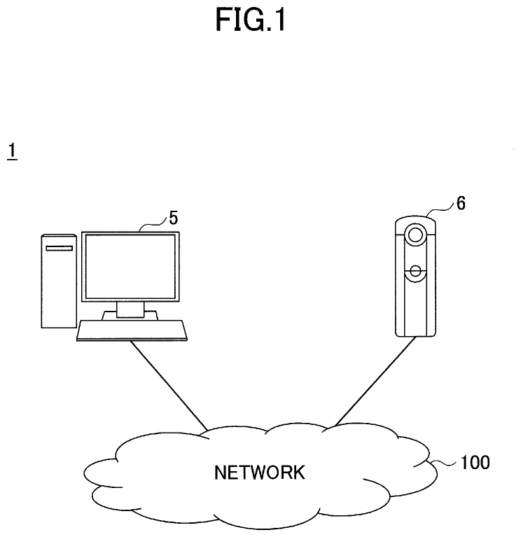

FIG. 1 is a diagram illustrating a configuration of a developing system according to an embodiment. As illustrated in FIG. 1, a developing system 1 includes a developing apparatus 5 and an omnidirectional camera 6. The developing apparatus 5 and the omnidirectional camera 6 are connected via a network 100 such as the Internet.

The developing apparatus 5 can be implemented by a computer on which a general-purpose operating system (OS) is installed. The developing apparatus 5 includes a wireless communication function or a wired communication function.

The omnidirectional camera 6 generates a spherical image based on a plurality of fisheye images captured with a plurality of fisheye optical systems. Further, the omnidirectional camera 6 includes a wireless communication function or a wired communication function, and outputs a spherical image to an external device such as a computer or a smartphone via the network 100.

Further, a fisheye image includes a circular fisheye image. Further, a spherical image includes an equirectangular projection image, but the present invention is not limited thereto. A spherical image may be any image as long as the spherical image is generated based on fisheye images.

Further, the omnidirectional camera 6 can output image data of an arranged image in which a plurality of captured raw fisheye images are arranged, and also image data of a thumbnail image, which will be described below, to the developing apparatus 5 via the network 100. The arranged image may be an uncompressed image, or the arranged image may be a file in which a plurality of fisheye images are combined. If the arranged image contains a plurality of fisheye images, the fisheye images may be arranged horizontally or vertically.

The developing apparatus 5 can perform the development process on an arranged image received from the omnidirectional camera 6 via the network 100.

In FIG. 1, the developing apparatus 5 and the omnidirectional camera 6 are connected via the network 100; however, the present invention is not limited thereto. The developing apparatus 5 and the omnidirectional camera 6 may be wirelessly connected, or may be directly connected in a wired manner.

### <Hardware Configuration of Omnidirectional Camera According to Embodiment>

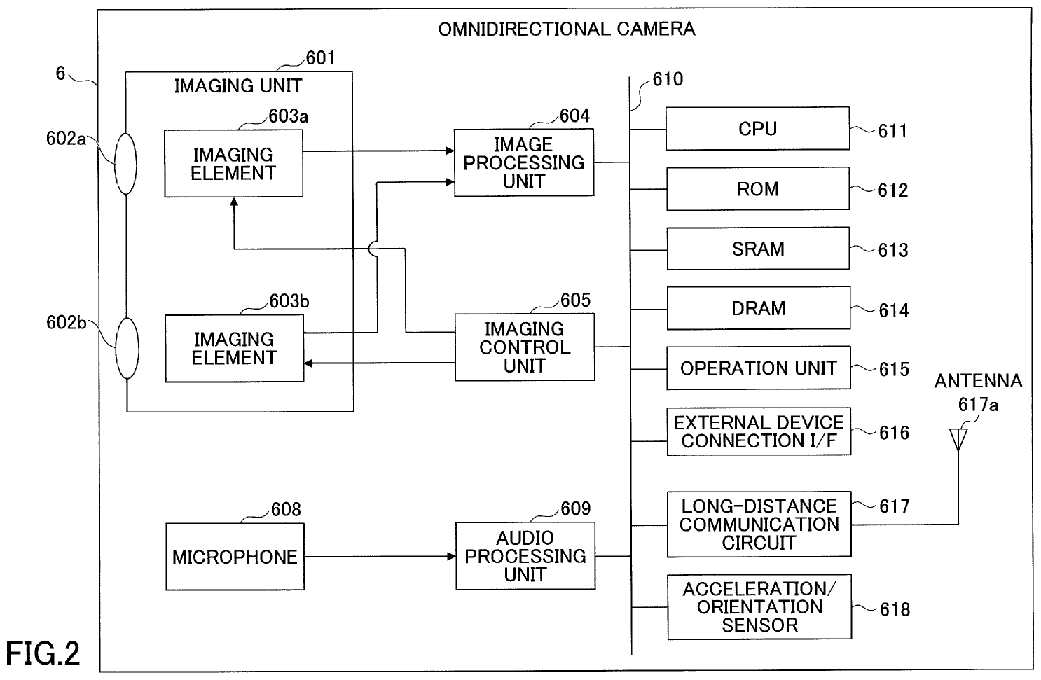

Next, referring to FIG. 2, a hardware configuration of the omnidirectional camera 6 will be described. FIG. 2 is a block diagram illustrating an example of the hardware configuration of the omnidirectional camera 6. In the following, the omnidirectional camera 6 will be described as an omnidirectional (a 360-degree) camera using two imaging elements. However, two or more imaging elements may be used. Further, the omnidirectional camera 6 is not required to be a camera dedicated to capturing omnidirectional images. An additional 360-degree imaging unit may be attached to a general-purpose digital camera or a smartphone, such that the digital camera or the smartphone can substantially function as the omnidirectional camera 6.

As illustrated in FIG. 2, the omnidirectional camera 6 includes an imaging unit 601, an image processing unit 604, an imaging control unit 605, a microphone 608, an audio processing unit 609, a CPU 611, a ROM 612, and a static random access memory (SRAM) 613. Further, the omnidirectional camera 6 includes a dynamic random access memory (DRAM) 614, an operation unit 615, an external device connection interface (I/F) 616, a long-distance communication circuit 617, an antenna 617a, and an acceleration/orientation sensor 618.

The imaging unit 601 includes fisheye lenses 602a and 602b that each have an angle of view of 180 degrees or more to form a hemispherical image. The imaging unit 601 also includes two imaging elements 603a and 603b provided in correspondence with the respective fisheye lenses 602a and 602b. The fisheye lenses 602a and 602b are each comprised of 6 groups of 7 lenses. The fisheye lenses 602a and 602 each have a total angle of view of 180 degrees (360 degrees/n, the number of optical systems n=2) or more, and preferably 190 degrees or more.

Although not illustrated in FIG. 2, the imaging unit 601 includes an aperture and a shutter corresponding to the fisheye lens 602a, and an aperture and a shutter corresponding to the fisheye lens 602b.

The imaging elements 603a and 603b include image sensors such as complementary metal oxide semiconductor (CMOS) sensors or charge-coupled device (CCD) sensors that convert optical images, captured with the fisheye lenses 602a and 602b, into image data in the form of electrical signals, and output the image data. Images captured by the imaging elements 603a and 603b with the fisheye lenses 602a and 602b are fisheye images or other images.

Further, the imaging elements 603a and 603b include timing generation circuits that generate horizontal or vertical synchronization signals or pixel clocks of the image sensors, and also include groups of registers for setting various commands and parameters necessary to operate the image sensors.

Each of the imaging elements 603a and 603b of the imaging unit 601 is connected to the image processing unit 604 via a parallel I/F bus. Further, each of the imaging elements 603a and 603b of the imaging unit 601 is connected to the imaging control unit 605 via a serial I/F bus (such as an I2C bus).

The image processing unit 604, the imaging control unit 605, and the audio processing unit 609 are connected to the CPU 611 via a bus 610. In addition, the ROM 612, the SRAM 613, the DRAM 614, the operation unit 615, the external device connection I/F 616, the long-distance communication circuit 617, and the acceleration/orientation sensor 618 are connected to the bus 610.

The image processing unit 604 loads image data of each of fisheye images output from the imaging element 603a and the imaging element 603b via the parallel I/F bus. Then, after performing a predetermined process on the image data of each of the fisheye images, the image processing unit 604 combines the image data to generate spherical image data.

The imaging control unit 605, which generally serves as a master device and uses the imaging elements 603a and 603b as slave devices, uses the I2C bus to set commands in the groups of registers of the imaging elements 603a and 603b. The imaging control unit 605 receives necessary commands from the CPU 611. Further, the imaging control unit 605 uses the I2C bus to load status data of the groups of registers of the imaging elements 603a and 603b, and sends the status data to the CPU 611.

Further, the imaging control unit 605 instructs the imaging elements 603a and 603b to output image data at a time when a shutter button of the operation unit 615 is pressed. The omnidirectional camera 6 may function to display a preview or a video on a display (such as a display of a smartphone). In this case, the imaging elements 603a and 603b continuously output image data at a predetermined frame rate (frame/minute).

Further, the imaging control unit 605 also functions as a synchronization control unit that synchronizes timing of image data output from the imaging elements 603a and 603b in cooperation with the CPU 611. In the embodiment, although the omnidirectional camera 6 is not provided with a display, a display unit may be provided.

The microphone 608 converts sounds into audio (signal) data. The audio processing unit 609 loads the audio data, output from the microphone 608, via an I/F bus, and performs a predetermined process on the audio data.

The CPU 611 controls the entire operation of the omnidirectional camera 6, and performs necessary processes. The ROM 612 stores various programs for the CPU 611. The SRAM 613 and the DRAM 614 are working memories, and store programs to be executed by the CPU 611 and data being processed, for example. The DRAM 614 stores image data being processed by the image processing unit 604 and already-processed spherical image data.

The operation unit 615 is a generic term for various operation buttons such as the shutter button. A user operates the operation unit 615 to input various imaging modes and imaging conditions.

The external device connection interface I/F 616 is an interface for connecting various types of external devices. Examples of the external devices include a universal serial bus (USB) memory and a PC. Spherical image data stored in the DRAM 614 is recorded in an external medium via the external device connection interface I/F 616, or transmitted to an external terminal (device) such as a smartphone via the external device connection interface I/F 616, as necessary.

The long-distance communication circuit 617 uses a near-field communication technique such as Wi-Fi, near-field communication (NFC), or Bluetooth (registered trademark) to communicate with an external terminal (device) such as a smartphone via the antenna 617a installed on the omnidirectional camera 6. The long-distance communication circuit 617 can also transmit spherical image data to an external terminal (device) such as a smartphone.

The acceleration/orientation sensor 618 calculates the direction of the omnidirectional camera 6 from terrestrial magnetism, and outputs direction information. The direction information is an example of related information (metadata) in accordance with the exchangeable image file format (Exif), and is used for image processing, such as image correction, of a captured image. In addition, the related information includes data such as a date and time when an image is captured and the volume of image data.

Further, the acceleration/orientation sensor 618 detects changes in angles (a roll angle, a pitch angle, and a yaw angle) in association with the movement of the omnidirectional camera 6. Information about the changes in angles is an example of related information (metadata) in accordance with the Exif, and is used for image processing, such as image correction, of a captured image.

Further, the acceleration/orientation sensor 618 detects acceleration in three axes. The omnidirectional camera 6 calculates the orientation of the omnidirectional camera 6 (the angle of omnidirectional camera 6 with respect to the gravity direction), based on the acceleration detected by the acceleration/orientation sensor 618. By including the acceleration/orientation sensor 618 in the omnidirectional camera 6, the accuracy of image correction can be improved.

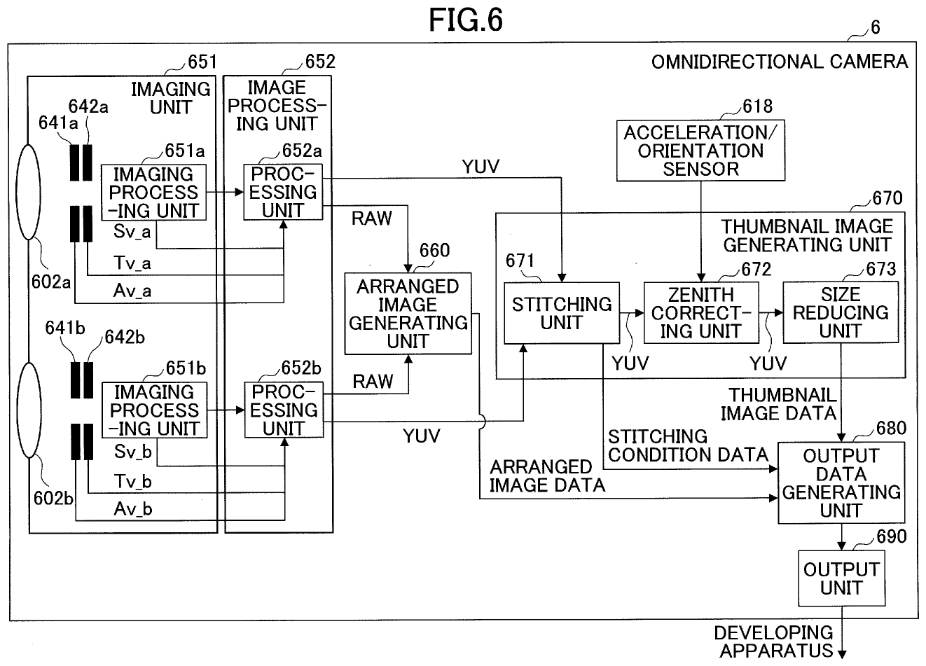

Various functions, which will be described with reference to FIG. 6, of the omnidirectional camera 6 according to the embodiment can be implemented by the hardware configuration illustrated in FIG. 2.

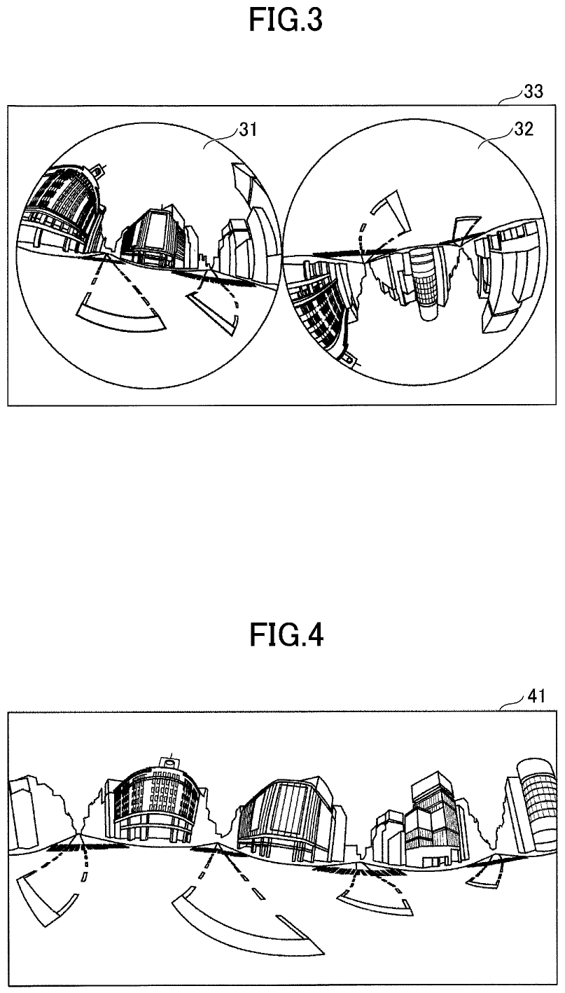

FIG. 3 is a diagram illustrating examples of fisheye images captured by the omnidirectional camera 6. A fisheye image 31 is captured by the fisheye lens 602a and the imaging element 603a, and a fisheye image 32 is captured by the fisheye lens 602b and the imaging element 603b. The RAW fisheye image 31 and the RAW fisheye image 32 are arranged (simply combined), thereby generating an arranged image 33.

Further, FIG. 4 is an example of a spherical image generated by the omnidirectional camera 6. The fisheye images 31 and 32 with an angle of view of 180 degrees or more are stitched to generate a spherical image 41 with a solid angle of 4π steradian (360 degrees).

### <Hardware Configuration of Developing Apparatus According to Embodiment>

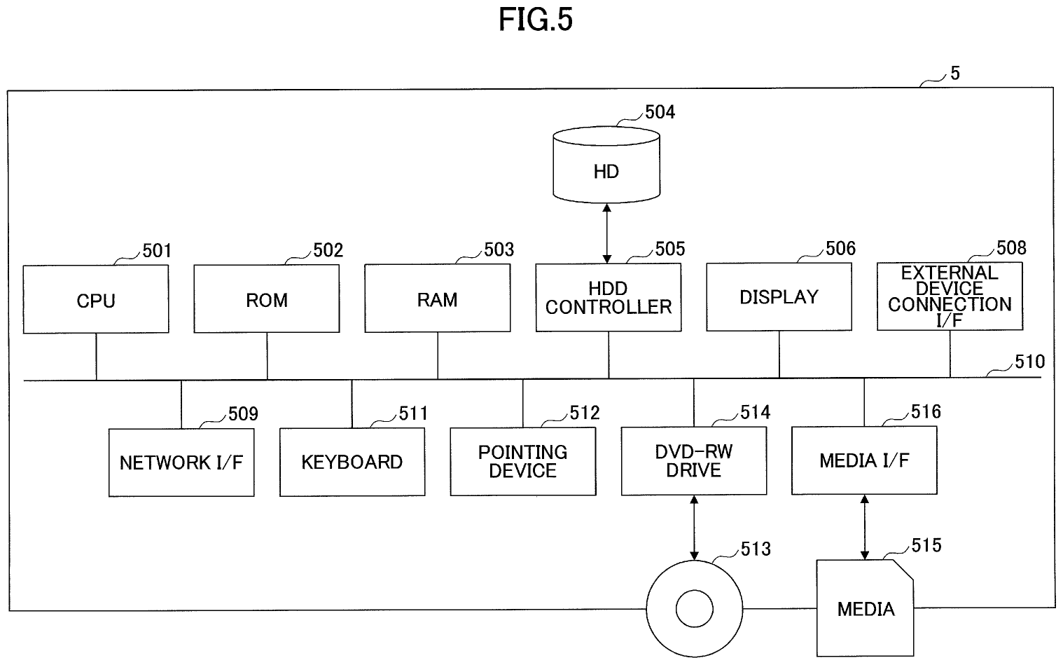

Next, referring to FIG. 5, a hardware configuration of the developing apparatus 5 will be described. FIG. 5 is a block diagram illustrating an example of the hardware configuration of the developing apparatus 5 according to the embodiment.

The developing apparatus 5 is configured by a computer. As illustrated in FIG. 5, the developing apparatus 5 includes a central processing unit (CPU) 501, a read-only memory (ROM) 502, a random-access memory (RAM) 503, a hard disk (HD) 504, and a hard disk drive (HDD) controller 505. Further, the developing apparatus 5 includes a display 506, an external device connection interface (I/F) 508, a network I/F 509, a data bus 510, a keyboard 511, a pointing device 512, a digital versatile disk rewritable (DVD-RW) drive 514, and a media I/F 516.

The CPU 501 controls the entire operation of the developing apparatus 5. The ROM 502 stores a program used to drive the CPU 501, such as an initial program loader (IPL). The RAM 503 is used as a work area for the CPU 501.

The HD 504 stores various data such as programs. The HDD controller 505 controls the reading or writing of various data from or to the HD 504, as controlled by the CPU 501. The display 506 displays various information such as a cursor, menus, windows, characters, and images.

The external device connection I/F 508 is an interface for connecting various types of external devices. Examples of the external devices include a universal serial bus (USB) memory and a printer. The network I/F 509 is an interface for data communication via the network 100. The data bus 510 is an address bus or a data bus for electrically connecting the elements, such as the CPU 501, illustrated in FIG. 5.

The keyboard 511 is a type of an input device having a plurality of keys for inputting characters, numbers, and various types of instructions. The pointing device 512 is a type of an input device that selects or executes various types of instructions, selects an object to be processed, and moves the cursor.

The DVD-RW drive 514 controls the reading or writing of various data from or to a DVD-RW 513. The DVD-RW 513 is an example of a removable recording medium. Note that the DVD-RW 513 is not limited to the DVD-RW, and may be a DVD-R. The media I/F 516 controls the reading or writing (storage) of data from or to (into) a recording media 515 such as a flash memory.

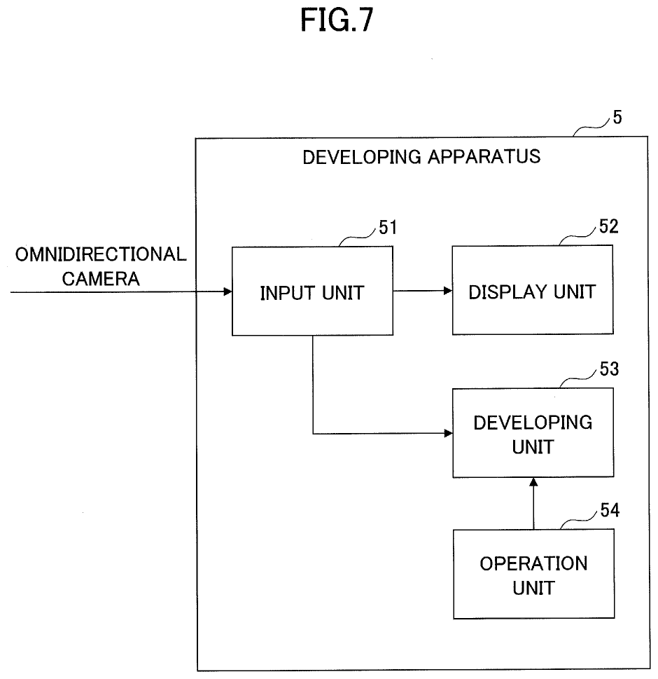

Various functions, which will be described below with reference to FIG. 7, of the developing apparatus 5 can be implemented by the hardware configuration illustrated in FIG. 5.

### First Embodiment

### <Functional Configuration of Omnidirectional Camera According to First Embodiment>

Next, referring to FIG. 6, a functional configuration of the omnidirectional camera 6 will be described. FIG. 6 is block diagram illustrating an example of the functional configuration of the omnidirectional camera 6. Note that FIG. 6 illustrates the concept of functional blocks, and the functional blocks are not required to be physically configured as illustrated in FIG. 6. All or some of the functional blocks may be functionally or physically separated or combined in any unit. Further, the omnidirectional camera 6 may include functions other than the functions illustrated in FIG. 6.

As illustrated in FIG. 6, the omnidirectional camera 6 includes an imaging unit 651, an image processing unit 652, an arranged image generating unit 660, a thumbnail image generating unit 670, an output data generating unit 680, and an output unit 690.

The imaging unit 651 is implemented by, for example, the imaging unit 601 and the imaging control unit 605. The imaging unit 651 includes an imaging processing unit 651a corresponding to the fisheye lens 602a and an imaging processing unit 651b corresponding to the fisheye lens 602b.

The imaging unit 651 captures fisheye images with the fisheye lenses 602a and 602b, and outputs image data of each of the two fisheye images to the image processing unit 652, together with imaging condition data used by the image processing unit 652 to perform appropriate image processing.

The imaging processing unit 651a is implemented by, for example, the imaging element 603a and the imaging control unit 605. The imaging processing unit 651a amplifies image data of a fisheye image, captured by the imaging element 603a, by a predetermined gain, and outputs the amplified image data to the image processing unit 652. The imaging processing unit 651b is implemented by, for example, the imaging element 603b and the imaging control unit 605. The imaging processing unit 651b amplifies image data of a fisheye image, captured by the imaging element 603b, by the predetermined gain, and outputs the amplified image data to the image processing unit 652.

The imaging condition data, output from the imaging unit 651, includes data Av_a indicating the diameter of an aperture 641a, data Tv_a indicating the speed of a shutter 642a, and data Sv_a indicating the gain of the imaging processing unit 651a. Further, the imaging condition data includes data Av_b indicating the diameter of an aperture 641b, data Tv_b indicating the speed of a shutter 642b, and data Sv_b indicating the gain of the image processing unit 651b. The imaging condition data is used as exposure data when image processing is performed on fisheye images.

The image processing unit 652 is implemented by, for example, the image processing unit 604. The image processing unit 652 includes a processing unit 652a corresponding to the fisheye lens 602a and a processing unit 652b corresponding to the fisheye lens 602b.

The image processing unit 652 receives the image data of each of the two fisheye images and the two pieces of imaging condition data from the imaging unit 651, and uses the two pieces of imaging condition data to perform image processing on the fisheye images. Then, the image processing unit 652 outputs processing results to the arranged image generating unit 660 and a stitching unit 671.

Examples of the image processing performed by the image processing unit 652 include exposure adjustment and shading correction of fisheye images. In two fisheye images captured by the omnidirectional camera 6, there may be a case in which one of the fisheye images is captured in a bright (high exposure) environment, and the other is captured in a dark (low exposure) environment. In addition, shading may occur in which the brightness decreases toward the periphery of a fisheye image. The difference in exposure between two fisheye images and shading may result in a decrease in the quality of a spherical image generated at a later stage.

The exposure adjustment and shading correction by the image processing unit 652 can minimize the difference in exposure between two fisheye images and shading at the periphery of a fisheye image. In this manner, two fisheye images can be smoothly stitched when a spherical image is generated at a later stage, thereby minimizing a decrease in the quality of the spherical image.

The processing unit 652a uses the data Ay_a, the data Tv_a, and the data Sv_a to perform processing such as exposure adjustment and shading correction on the fisheye image captured with the fisheye lens 602a. Then, the processing unit 652a outputs RAW image data of the processed fisheye image to the arranged image generating unit 660, and outputs YUV image data of the processed fisheye image to the stitching unit 671.

The processing unit 652b uses the data Av_b, the data Tv_b, and the data Sv_b to perform processing such as exposure adjustment and shading correction on the fisheye image captured with the fisheye lens 602b. Then, the processing unit 652b outputs RAW image data of the processed fisheye image to the arranged image generating unit 660, and outputs YUV image data of the processed fisheye image to the stitching unit 671.

The arranged image generating unit 660 is implemented by, for example, the CPU 611. The arranged image generating unit 660 arranges the two pieces of RAW image data of the respective fisheye images received from the processing units 652a and 652b, and generates an arranged image 33 (see FIG. 3). In this case, the fisheye images may be rotated by 90 degrees or may be inverted, in accordance with the design of image-forming optical systems such as the fisheye lenses 602a and 602b. The arranged image generating unit 660 outputs image data of the generated arranged image 33 to the output data generating unit 680.

The thumbnail image generating unit 670 is implemented by, for example, the CPU 611. The thumbnail image generating unit 670 includes the stitching unit 671, a zenith correcting unit 672, and a size reducing unit 673. The thumbnail image generating unit 670 uses the YUV image data of the two fisheye images, received from the processing units 652a and 652b, to generate a thumbnail image that includes at least a part of a reduced-size spherical image. Then, the thumbnail image generating unit 670 outputs the generated thumbnail image to the output data generating unit 680.

As used herein, the term “thumbnail image” refers to an identification image (a sample image) whose size is reduced when displayed on a user interface (UI) in order to increase visibility. The thumbnail image according to the embodiment is generated by including a reduced-size spherical image, and serves as a sample image such that the arranged image 33 can be identified with high visibility.

The stitching unit 671 generates one spherical image by stitching together the YUV image data of the fisheye image, received from the processing unit 652a, and the YUV image data of the fisheye image, received from the processing unit 652b, based on equirectangular projection. Then, the stitching unit 671 outputs image data of the generated spherical image to the zenith correcting unit 672.

In a region where two fisheye images overlap, the position (coordinates) of an object may dynamically change due to parallax of the object between the images and the distances to the object included in the images. Therefore, the stitching unit 671 can use an image processing technique such as template matching to perform a dynamic stitching process.

The stitching unit 671 retains stitching condition data such as stitching positions used in the above-described stitching process, and outputs the stitching condition data to the output data generating unit 680.

The zenith correcting unit 672 receives data indicating the orientation angle of the omnidirectional camera 6 from the acceleration/orientation sensor 618, and corrects the spherical image received from the stitching unit 671 such that the zenith direction of the spherical image matches a predetermined reference direction. A timing at which the data indicating the orientation angle is received from the acceleration/orientation sensor 618 is a center timing of an exposure period of time in which the imaging elements 603a and 603b are exposed.

Note that the predetermined reference direction is typically a vertical direction in which the acceleration of gravity acts. By correcting the spherical image such that the zenith direction of the spherical image matches the vertical direction (upward direction), discomfort such as simulator sickness is less likely to be experienced by a user even if the user is viewing a video and the field of view is changed. The zenith correcting unit 672 outputs the processed spherical image to the size reducing unit 673.

In the stitching process and the zenith correction process, because rectangular conversion is performed, resolution may decrease due to pixel interpolation. For this reason, it is preferable for the stitching unit 671 and the zenith correcting unit 672 to perform the stitching process and the zenith correction process simultaneously at a time of rectangular conversion. Accordingly, it is possible to reduce the number of times pixel interpolation is performed in association with rectangular conversion, thus minimizing a decrease in resolution.

Note that the known technique disclosed in Japanese Patent No. 6256513 can be applied to the above-described process for generating a spherical image from two fisheye images, and thus a detailed description thereof will be omitted.

The size reducing unit 673 reduces the size of the spherical image to a predetermined image size. Then, the size reducing unit 673 generates a thumbnail image that includes at least a part of the spherical image whose size has been reduced, and outputs the thumbnail image to the output data generating unit 680. Note that the thumbnail image may include characters and symbols serving as identification information of the arranged image 33, in addition to the reduced-size spherical image.

Accordingly, from the two fisheye images, the thumbnail image generating unit 670 can generate the reduced-size spherical image to which the processing results obtained from the stitching unit 671, the zenith correcting unit 672, and the size reducing unit 673 have been applied.

The output data generating unit 680 is implemented by, for example, the CPU 611. The output data generating unit 680 generates output data by combining the image data of the arranged image 33, the image data of the thumbnail image, and the stitching condition data into one electronic file, and outputs the generated output data to the output unit 690. The electronic file is an image file recorded in the digital negative (DNG) format. The output data generating unit 680 may record the stitching condition data as part of metadata about the electronic file, generated as the output data.

The output unit 690 is implemented by, for example, an external device connection I/F 616. The output unit 690 outputs the output data, received from the output data generating unit 680, to the developing apparatus 5. Alternatively, the output unit 690 may output the output data to an internal memory, such as the SRAM 613, for storage, or may output the output data to an external storage device via the external device connection I/F 616 for storage.

By including the stitching condition data in the output data, the processing load, such as detecting stitching positions, and also the processing time can be reduced when two fisheye images are stitched together in the developing apparatus 5.

### <Functional Configuration of Developing Apparatus According to Embodiment>

Next, referring to FIG. 7, a functional configuration of the developing apparatus 5 will be described. FIG. 7 is a block diagram illustrating a functional configuration of the developing apparatus 5. As illustrated in FIG. 7, the developing apparatus 5 includes an input unit 51, a display unit 52, a developing unit 53, and an operation unit 54.

The input unit 51 is implemented by, for example, the external device connection I/F 508. The input unit 51 receives the output data, including the image data of the arranged image 33, the image data of the thumbnail image, and the stitching condition data, from the omnidirectional camera 6 via the network 100, and outputs the output data to the display unit 52 and the developing unit 53.

The display unit 52 is implemented by, for example, the display 506. The display unit 52 displays the arranged image 33 and/or the thumbnail image on a UI screen of the display 506, and makes the arranged image 33 and/or the thumbnail image visible to the user. The display unit 52 can also display, on the UI screen, a plurality of arranged images and/or a plurality of thumbnail images previously received from the omnidirectional camera 6 and stored in the HD 504, and make the plurality of arranged images and/or thumbnail images visible to the user.

From a plurality of thumbnail images displayed on the UI screen, the user selects a thumbnail image corresponding to an arranged image to which to perform the RAW development process. The display unit 52 displays the arranged image corresponding to the selected thumbnail image on the UI screen.

The developing unit 53 performs the RAW development process on the arranged image displayed on the UI screen. The user can manually set conditions for the RAW development process by using the operation unit 54, while performing the development process on the arranged image displayed on the UI screen or while viewing the arranged image that has been subjected to the development process. Alternatively, the RAW development process may be automatically performed based on predetermined conditions.

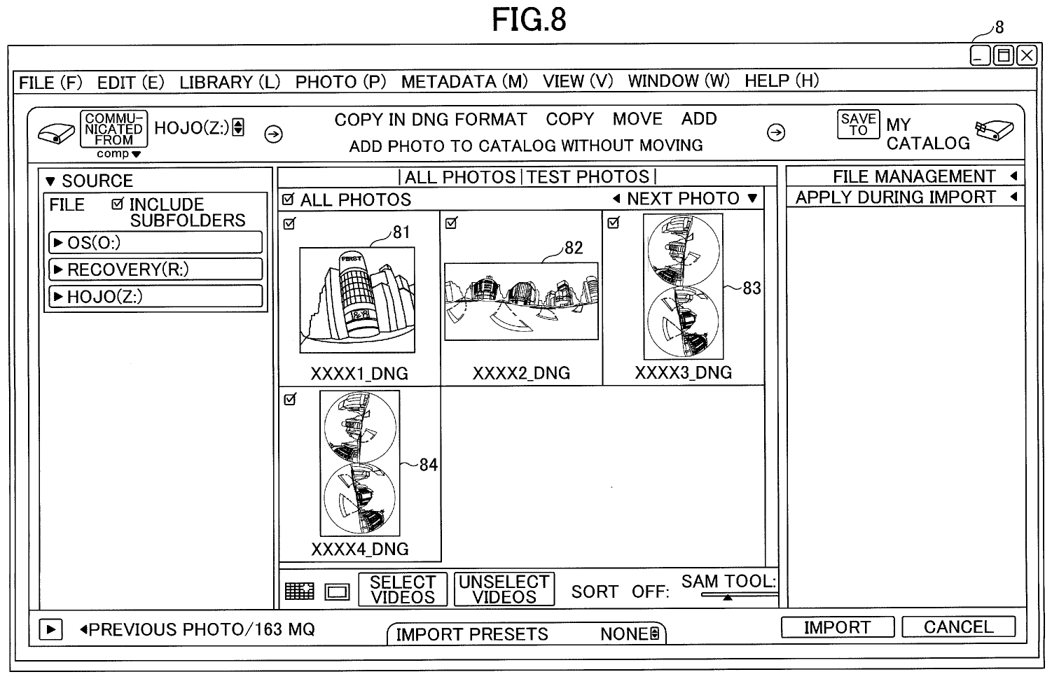

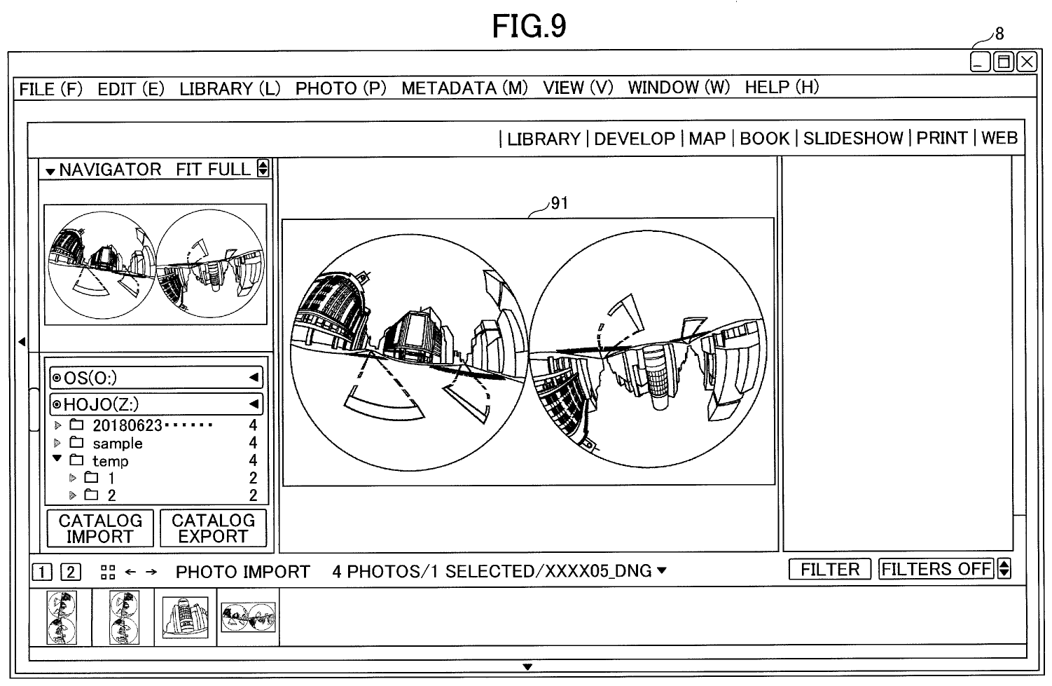

Referring to FIG. 8 and FIG. 9, the UI screen displayed by the display unit 52 will be described. FIG. 8 is a diagram illustrating an example of a screen displaying thumbnail images according to the embodiment and thumbnail images according to a comparative example. FIG. 9 is a diagram illustrating an example of a screen displaying an arranged image according to the embodiment.

As illustrated in FIG. 8, thumbnail images 81 and 82 according to the embodiment and thumbnail images 83 and 84 according to the comparative example are displayed on a UI screen 8. The thumbnail images 81 and 82 according to the embodiment are spherical images whose sizes are reduced. Each of the thumbnail images 83 and 84 according to the comparative example is an arranged image whose size is reduced and in which two RAW fisheye images captured by an omnidirectional camera are arranged.

The user uses the pointing device 512 to operate the cursor on the UI screen 8, while viewing the thumbnail images displayed on the UI screen 8. Then, when the user presses, for example, the return key of the keyboard 511 with the cursor being positioned on the thumbnail image 82, an arranged image 91 corresponding to the thumbnail image 82 is displayed on the UI screen 8, as illustrated in FIG. 9. The user can perform the RAW development process on the arranged image 91, while viewing the arranged image 91 displayed on the UI screen 8.

Conversely, each of the thumbnail images 83 and 84 is an arranged image in which two fisheye images are arranged. Therefore, even if the user looks at a thumbnail image, it would be difficult for the user to identify at a glance where an arranged image was captured.

In view of the above, the thumbnail images 81 and 82 according to the embodiment are reduced-size spherical images. Therefore, the user can readily identify at a glance where an arranged image was captured by looking at a thumbnail image. Accordingly, by increasing the visibility of a thumbnail image, it becomes possible for the user to readily identify where each arranged image was captured. In addition, the management of arranged images can be facilitated.

### <Process Performed by Developing System According to First Embodiment>

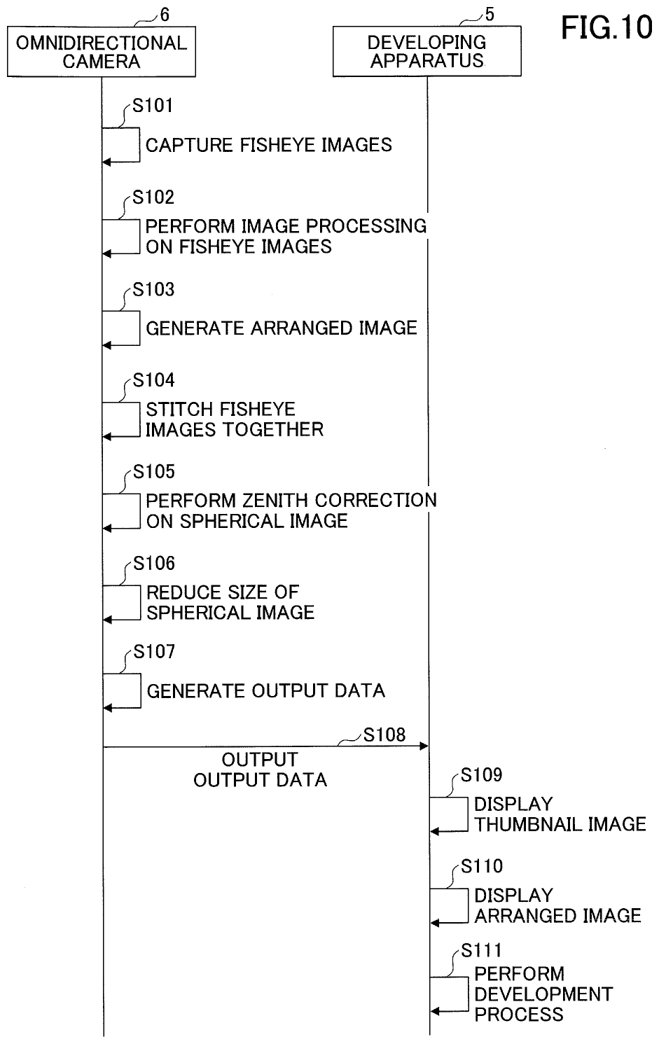

Next, referring to FIG. 10, a process performed by the developing system 1 according to the first embodiment will be described. FIG. 10 is a sequence diagram illustrating an example of the process performed by the developing system 1 according to the first embodiment.

In FIG. 10, in step S101, the imaging unit 651 of the omnidirectional camera 6 captures fisheye images with the respective fisheye lenses 602a and 602b, and outputs image data of each of the two fisheye images to the image processing unit 652, together with imaging condition data used by the image processing unit 652 to perform appropriate image processing.

Next, in step S102, the image processing unit 652 uses the imaging condition data to perform image processing on the two fisheye images, and outputs processing results to the arranged image generating unit 660 and the stitching unit 671. This image processing includes exposure adjustment and shading correction.

Next, in step S103, the arranged image generating unit 660 arranges two pieces of RAW image data of the respective fisheye images, received from the image processing unit 652, to generate an arranged image 33. Then, the arranged image generating unit 660 outputs image data of the generated arranged image 33 to the output data generating unit 680.

Next, in step S104, the stitching unit 671 of the thumbnail image generating unit 670 performs the stitching process for stitching together two pieces of YUV data of the respective fisheye images, received from the image processing unit 652, to generate a spherical image, and outputs image data of the spherical image to the zenith correcting unit 672. Further, the stitching unit 671 outputs stitching condition data including stitching positions used in the stitching process to the output data generating unit 680.

Next, in step S105, the zenith correcting unit 672 receives data indicating the orientation angle of the omnidirectional camera 6 from the acceleration/orientation sensor 618, and corrects the spherical image received from the stitching unit 671 such that the zenith direction of the spherical image matches the predetermined reference direction. Then, the zenith correcting unit 672 outputs the spherical image that has been subjected to the correction process to the size reducing unit 673.

Next, in step S106, the size reducing unit 673 reduces the size of the received spherical image to a predetermined image size. Then, the size reducing unit 673 generates a thumbnail image that includes at least a part of the reduced-size spherical image, and outputs image data of the generated thumbnail image to the output data generating unit 680.

Next, in step S107, the output data generating unit 680 generates output data by combining the image data of the arranged image 33, the image data of the thumbnail image, and the stitching condition data into one electronic file, and outputs the generated output data to the output unit 690.

Next, in step S108, the output unit 690 outputs the output data, received from the output data generating unit 680, to the developing apparatus 5. The input unit 51 of the developing apparatus 5 receives the output data, including the image data of the arranged image 33, the image data of the thumbnail image, and the stitching condition data, via the network 100, and outputs the output data to the display unit 52 and the developing unit 53.

Next, in step S109, the display unit 52 displays the thumbnail image on the UI screen 8. Further, the display unit 52 also displays a plurality of thumbnail images, previously received from the omnidirectional camera 6 and stored in the HD 504, on the UI screen 8.

Next, in step S110, when the user selects a thumbnail image from the plurality of thumbnail images displayed on the UI screen, the display unit 52 displays, on the UI screen, an arranged image corresponding to the selected thumbnail image.

Next, in step S111, the developing unit 53 performs the RAW development process on the arranged image displayed on the UI screen.

Accordingly, the developing system 1 can perform the development process on a spherical image captured by the omnidirectional camera 6.

### <Effects of Developing System According to First Embodiment>

In a related-art developing system, in one-time photographing, an omnidirectional camera outputs the number of DNG files (RAW image data) same as the number of a plurality of fisheye lenses of the omnidirectional camera. Therefore, a large number of DNG files are stored in a developing apparatus.

If the developing apparatus were to store a large number of DNG files, it would be preferable for the DNG files captured at the same scene to be associated with each other and managed. However, in the related-art developing system, thumbnail images for identifying the DNG files are fisheye images. Therefore, even if the user visually checks a thumbnail image, it would be difficult for the user to identify where an arranged image corresponding to the thumbnail image was captured.

Further, there is known a related-art omnidirectional camera that captures a plurality of fisheye images with a plurality of fisheye lenses, generates an arranged image by arranging the plurality of fisheye images, and outputs the arranged image in the DNG file format. However, in the related-art omnidirectional camera, because a thumbnail image for the DNG file is the arranged image in which the plurality of fisheye images are arranged, it would be difficult for the user to identify, from the thumbnail image, where the arranged image corresponding to the thumbnail image was captured.

As described above, in the related-art techniques, the visibility of thumbnail images is low. Therefore, the management of DNG files, which are subjected to a development process, may be sometimes difficult.

In view of the above, in the present embodiment, a thumbnail image that includes at least a part of a reduced-size spherical image is displayed on the UI screen. Therefore, by looking at the thumbnail image, the user can readily identify where an arranged image corresponding to the thumbnail image was captured. Accordingly, by increasing the visibility of a thumbnail image, it becomes possible for the user to readily identify where each arranged image was captured. In addition, the management of arranged images can be facilitated.

Further, in the present embodiment, output data, output to the developing apparatus 5, includes stitching condition data such as stitching positions used in the stitching process. Therefore, the processing load, such as detecting stitching positions, and also the processing time can be reduced when two fisheye images are stitched together in the developing apparatus 5.

### Second Embodiment

Next, a developing system according to a second embodiment will be described. A description of the same elements as those of the above-described embodiment will be omitted.

Due to variations in a manufacturing process of the fisheye lenses 602a and 602b or the imaging elements 603a and 603b, spectral sensitivity characteristics may differ between two fisheye images captured by the imaging unit 651. If two fisheye images that have different hues due to different spectral sensitivity characteristics are stitched together, a generated spherical image may become unnatural.

As a measure of hue, hue may be sometimes represented as each color gain of an image. As a specific example, there are assumed to be one fisheye image with a red (R) gain of 2.0 and a blue (B) gain of 2.0 and the other fisheye image with a red (R) gain of 1.95 and a blue (B) gain of 2.05.

In this case, as compared to the one fisheye image, the other fisheye image appears as reddish. In the case of an arranged image generated from fisheye images having different hues, considerable work and time may be required if the hues are corrected during the RAW development process in the developing apparatus 5.

In view of the above, an omnidirectional camera of the developing system according to the second embodiment includes a spectral sensitivity correcting unit. The spectral sensitivity correcting unit is configured to correct a difference in spectral sensitivity characteristics between two fisheye images, before generating an arranged image. In the following, details will be described.

### <Functional Configuration of Omnidirectional Camera According to Second Embodiment>

A developing system la according to the second embodiment includes the developing apparatus 5 and an omnidirectional camera 6a.

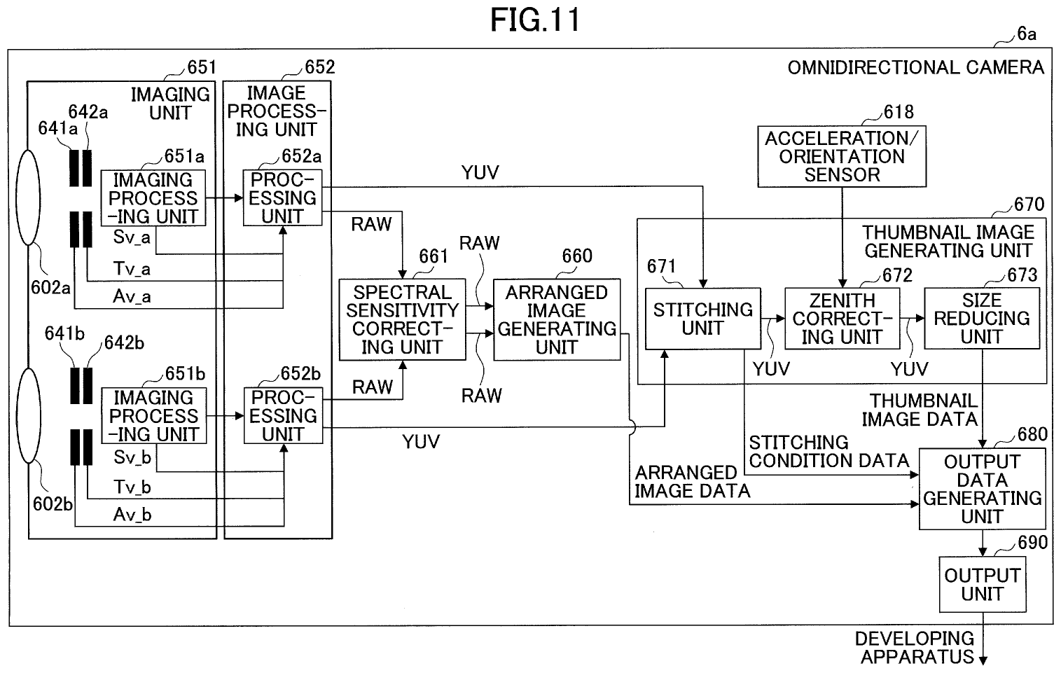

FIG. 11 is a block diagram illustrating an example of a functional configuration of the omnidirectional camera 6a according to the second embodiment. As illustrated in FIG. 11, the omnidirectional camera 6a includes a spectral sensitivity correcting unit 661.

The spectral sensitivity correcting unit 661 functions to correct a difference in spectral sensitivity characteristics between two fisheye images output from the image processing unit 652. Referring to the above example, in the one fisheye image with the red (R) gain of 2.0 and the blue (B) gain of 2.0, the spectral sensitivity correcting unit 661 performs gain adjustment such that the red gain is 2.00/1.95=1.026 (times).

Further, in the other fisheye image with the red (R) gain of 1.95 and the blue (B) gain of 2.05, the spectral sensitivity correcting unit 661 performs gain adjustment such that the blue gain is 2.05/2.00=1.025 (times).

In other words, in order to secure saturation, the spectral sensitivity correcting unit 661 performs gain adjustment of 1.0 times or more. By the above-described gain adjustment, two RAW fisheye images can be obtained as if the images were captured by one combination camera of a fisheye optical system and an imaging element.

### <Process Performed by Developing System According to Second Embodiment>

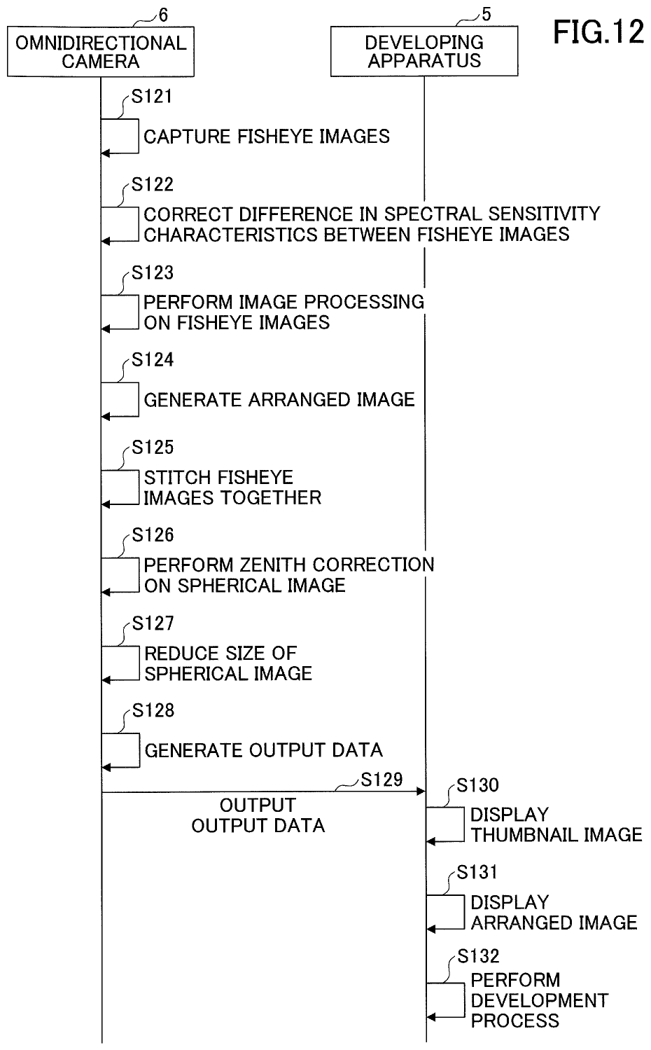

FIG. 12 is a sequence diagram illustrating an example of a process performed by the developing system la according to the second embodiment.

In FIG. 12, step S121 is the same as the step S101 in FIG. 10, and steps S123 through S132 in FIG. 12 are the same as steps S102 through S111 in FIG. 10. Therefore, a description thereof will be omitted.

In step S122, the spectral sensitivity correcting unit 661 corrects a difference in spectral sensitivity characteristics between two fisheye images output from the image processing unit 652. Then, the spectral sensitivity correcting unit 661 outputs the corrected two fisheye images to the arranged image generating unit 660.

In the above-described manner, the developing system la can perform the development process on a spherical image captured by the omnidirectional camera 6a.

As described above, in the second embodiment, the omnidirectional camera 6a includes the spectral sensitivity correcting unit 661.

Therefore, the processing load and the processing time of the RAW development process performed by the developing apparatus 5 can be reduced.

Note that the omnidirectional camera 6a may also include a functional unit configured to perform a process for correcting transverse chromatic aberration, in addition to the spectral sensitivity correcting unit 661. Accordingly, the processing load and the processing time of the RAW development process performed by the developing apparatus 5 can be further reduced.

Effects other than those described above are the same as those described in the first embodiment.

Although specific embodiments have been described above, the present invention is not limited to the above-described embodiments. Variations and modifications may be made to the described subject matter without departing from the scope of the present invention.

Further, the embodiments also include an imaging method. For example, the imaging method includes capturing a plurality of fisheye images;

generating an arranged image in which the plurality of fisheye images are arranged; generating a thumbnail image that includes at least a part of a spherical image, the spherical image being generated based on the plurality of fisheye images; and outputting output data that includes the arranged image and the thumbnail image. With the above imaging method, it is possible to obtain effects similar to those of the above-described developing system.

Further, the embodiments also include a non-transitory recording medium. For example, the non-transitory recording medium stores a program for causing a computer to execute an imaging process including capturing a plurality of fisheye images; generating an arranged image in which the plurality of fisheye images are arranged; generating a thumbnail image that includes at least a part of a spherical image, the spherical image being generated based on the plurality of fisheye images; and outputting output data that includes the arranged image and the thumbnail image. With the above program, it is possible to obtain effects similar to those of the above-described developing system.

According to an embodiment of the present invention, it is possible to increase the visibility of a thumbnail image so as to allow a user to identify at a glance where an image was captured.

What is claimed is

1. An imaging system comprising:
an imaging unit configured to capture a plurality of fisheye images;
an arranged image generating unit configured to generate a first arranged image in which the plurality of fisheye images are arranged;
a thumbnail image generating unit configured to generate a thumbnail image that includes at least a part of a spherical image, the spherical image being generated based on the plurality of fisheye images; and
an output unit configured to output output data that includes the first arranged image and the thumbnail image.

2. The imaging system according to claim 1, further comprising a spectral sensitivity correcting unit configured to correct a difference in spectral sensitivity characteristics between the plurality of fisheye images, and wherein
the arranged image generating unit generates a second arranged image in which the plurality of corrected fisheye images are arranged.

3. The imaging system according to claim 1, wherein the thumbnail image generating unit includes
a stitching unit configured to stitch the plurality of fisheye images together to generate the spherical image, and
a zenith correcting unit configured to correct a zenith direction of the spherical image in accordance with an orientation of the imaging system, and
a size reducing unit configured to reduce a size of the corrected spherical image.

4. The imaging system according to claim 3, wherein the output data includes stitching condition data used by the stitching unit to generate the spherical image.

5. A developing system comprising:
an imaging system; and
a developing apparatus,
wherein the imaging system includes
an imaging unit configured to capture a plurality of fisheye images,
man arranged image generating unit configured to generate an arranged image in which the plurality of fisheye images are arranged,
a thumbnail image generating unit configured to generate a thumbnail image that includes at least a part of a spherical image, the spherical image being generated based on the plurality of fisheye images, and
an output unit configured to output output data that includes the arranged image and the thumbnail image, and
wherein the developing apparatus includes
a display unit configured to display at least one of the arranged image and the thumbnail image included in the output data, the output data being received from the imaging system, and
a developing unit configured to perform a development process on the arranged image included in the output data.

6. An imaging method comprising:
capturing a plurality of fisheye images;
generating an arranged image in which the plurality of fisheye images are arranged;
generating a thumbnail image that includes at least a part of a spherical image, the spherical image being generated based on the plurality of fisheye images; and
outputting output data that includes the arranged image and the thumbnail image.
